(19) United States
(12) Patent Application Publication
(10) Pub. No.: US 2004/0103320 A1
(43) Pub. Date: May 27, 2004

(54) Multiple network access

(76) Inventors: Guy Storer, Stevenage (GB); Peter John Kick, Dereham (GB)

Correspondence Address: BARNES & THORNBURG, P.O. BOX 2786, CHICAGO, IL, 60690-2786, US

(21) Appl. No.: 10/700,248

(22) Filed: Nov. 3, 2003

(30) Foreign Application Priority Data
Nov. 20, 2002 (GB) GB 0227065.0

(51) Int. Cl. G06F 11/30

(52) U.S. Cl. 713/201; 709/225

(57) ABSTRACT

A computer system comprises first and second networks, the second network being protected by a firewall. The first network includes a first terminal server, which is granted permission to access the second network through the firewall. The second network includes a second terminal server, including a number of application programs that can be run remotely. A user on the first network who has successfully logged on to the first terminal server is then enabled to log on to the second terminal server through the first terminal server, and may then remotely run application programs in the second server. The invention finds particularly application in enabling support staff to access multiple networks, to enable them to diagnose and fix problems.

### BACKGROUND TO THE INVENTION

This invention relates to techniques for access to multiple computer networks through multiple firewalls.

The invention is particularly although not exclusively concerned with enabling support staff to access multiple networks, to enable them to diagnose and fix problems.

The purpose of a firewall is to protect a computer system or network from external attacks. A firewall allows objects inside the firewall to access objects outside, but prevents objects outside the firewall from accessing objects inside it, unless they have been specifically granted access. Usually, access is granted only to a specified set of IP (Internet Protocol) addresses recognised by the firewall as having access permission.

One known method of enabling support staff to access a customer's network inside a firewall is to grant access through the firewall to one or more specified workstations. However, this has the disadvantage that only the specified workstations may be used, which causes problems if support staff are mobile and wish to use other workstations. Also, there are problems with this method if the customer's network uses NAT (Network Address Translation), preventing name to IP address resolution by traditional methods.

Another known method is to connect the support workstations directly to the customer's network, so that the workstations are inside the firewall. However, this means that only these particular workstations may be used, and each workstation is limited to use with the particular customer.

The object of the present invention is to overcome these problems.

### SUMMARY OF THE INVENTION

According to the invention, a computer system comprises a first network connected to a plurality of further networks,

(a) the first network including a plurality of client computers and a first server computer, having log-on software for allowing a user at any one of the client computers to log on to the first server computer,

(b) the further networks having respective firewalls, the first server computer having permission to access the further networks through their respective firewalls,

(c) each of the further networks including a further server computer having log-on software for allowing a user currently logged on at the first server computer also to log on to the further server computer through the first server computer, and

(d) the further server computer including terminal server software for enabling a remote desktop session to be run on the further server computer from any of the client computers, thereby allowing a user at any of the client computers to remotely run application software in the further server computer.

It can be seen that the invention enables an authorised user to access the second network from any workstation on the first network. However, firewall access needs to be granted only to the first server.

In the case of a support system, the first network may belong to the IT support service provider, and the second network may be a customer's network. The application programs on the second server may comprise tools for diagnosing and repairing faults on the customer's network.

### BRIEF DESCRIPTION OF THE DRAWINGS

FIG. 1 shows a computer system, comprising an IT support service provider's network connected to a number of customers' networks.

FIG. 2 is a flowchart showing the operation of the system.

### DESCRIPTION OF AN EMBODIMENT OF THE INVENTION

One embodiment of the invention will now be described by way of example with reference to the accompanying drawings.

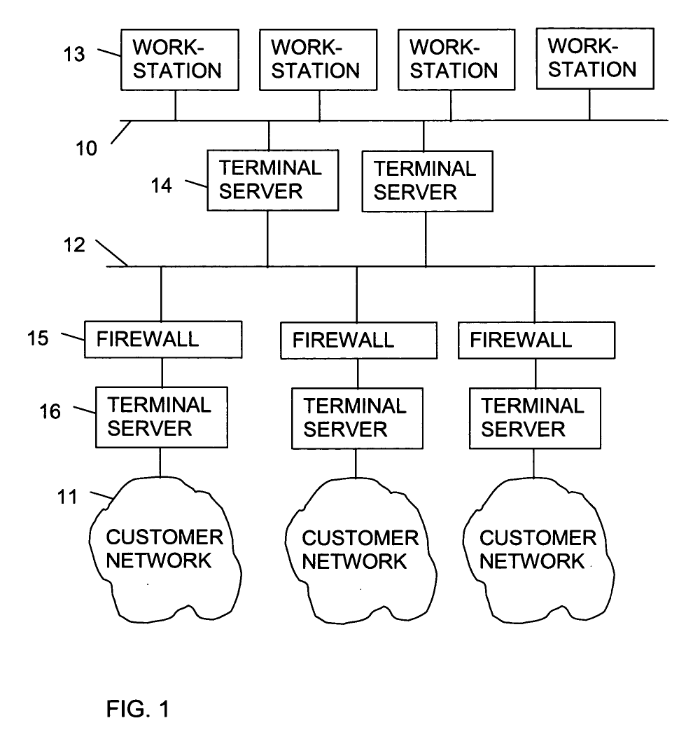

FIG. 1 shows a computer system, comprising an IT support service provider's network 10 connected to a number of customers' networks 11, by way of a direct network connection or an external network 12 such as the Internet. The IT support service provider's network 10 includes a number of support workstations 13, and a terminal server cluster 14. Each of the customers' networks 11 includes a firewall 15, to protect it from external attacks, and a terminal server cluster 16, located on the inside of the firewall.

In the present embodiment, the terminal servers 14 and 16 run Microsoft Windows 2000 Server or Advanced Server, with Microsoft Terminal Services enabled in application mode. With Terminal Services, terminal emulation software running on a client system provides remote access to a server-based Windows 2000 desktop.

The terminal emulation software sends keystrokes and mouse movements to the server. The server does all application execution, data processing and data storage and passes back only the display updates (and possibly sounds) to the terminal emulation software in the client. This reduces the network bandwidth requirements between the server and client. In addition, display information is cached at the client side to improve efficiency. Users can gain access to Terminal Services via TCP/IP, through almost any network connection medium. The end user experience is almost identical to logging on to the server directly.

As shown, in this embodiment there are two terminal servers 14 on the service provider's network. The multiple terminal servers share the system load utilising “Network Load Balancing”, and provide resilience in the event of a server failure. Similarly, more than one terminal server 16 may be provided on each of the customers' networks.

The terminal servers 14 on the service provider's network are given firewall permissions on each of the firewalls 15, enabling a connection to be made, utilising TCP port 3389 (Remote Desktop Protocol), to the terminal servers 16 on the customers' networks. This enables a remote desktop session to be run on a server on a customer's network from any of the workstations 13 on the service provider's network, via the terminal server 14 on the service provider's network.

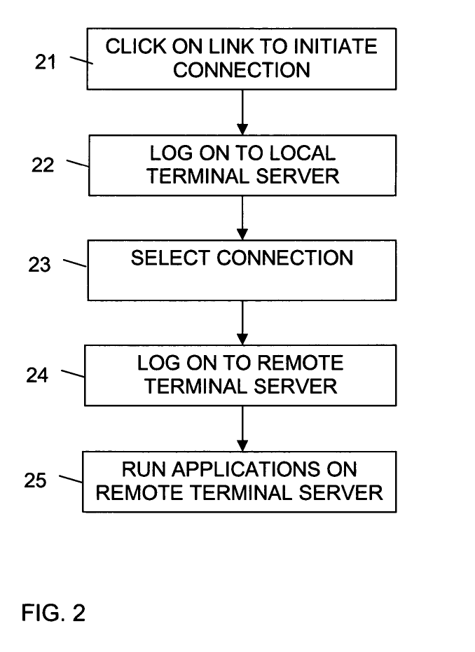

The operation of the system will now be described with reference to the flow chart in FIG. 2.

(Step 21) To use the system, a user (e.g. a helpdesk agent) connects to a predetermined web page, by way of a conventional web browser, and then clicks on a link in that page to initiate the connection. The web page may be hosted on the terminal servers 14, or on some other web server. This causes a log-on request to be sent to one of the terminal servers 14. Connections are balanced between the two servers 14 according to load.

(Step 22) The terminal server 14 presents the user with a conventional log-on window, allowing the user to enter his or her user name and password. The terminal server 14 checks that the user is authorised, and that the password is valid. If so, the user is logged on to the server.

(Step 23) Once logged on to the terminal server 14, a terminal server session is opened within the user's web browser, and presents a web page offering connections to those customers for which this particular user has access permission. The permitted connections are conveniently presented as a drop-down list or combo box from which the user can select.

(Step 24) When the user selects a customer, a connection is made to the terminal server 16 in the selected customer's network. The terminal server 16 presents the user with a conventional log-on window, allowing the user to enter his or her user name and password. The terminal server 16 checks that the user is authorised, and that the password is valid. If so, the user is logged on to this server.

(Step 25) Once logged on to the terminal server 16, the user can perform the same operations from within the terminal server session as they would from a workstation connected directly to the customer's network 11. In particular, the user can run support applications for diagnosing and repairing faults on the customer's network. These include GUI versions of a number of command line utilities such as Ping, enabling these to be run without a command prompt.

The terminal server 16 may provide a custom interface for each user, allowing each user access to only a predetermined set of applications that they have been given permission to use. The custom interface provides complete access control of all applications without the need for Group Policies to lock down the user desktop, ensuring that the system can be implemented without modification of the existing configuration. Applications are made available by placing shortcuts in a dedicated folder and setting relevant NTFS permissions (group or individual) on the shortcut. The custom interface reads the contents of the folder and, if the user has rights to an application, displays an icon for that application in a panel on the custom interface window. The user can then launch an application by clicking on its icon. A log file is maintained with a record of all applications launched, including the time and user name.

The user can switch between multiple terminal server sessions and local desktop as required. Remote control of a session is also possible to enable training or additional help if required.

The advantages of the system described above can be summarised as follows.

The user is not restricted to a particular workstation, but may be at any workstation 13 on the service provider's network 10.

The system is secure, in that Terminal Services Remote Desktop Protocol uses RSA Security's RC4 cipher, a stream cipher designed to efficiently encrypt small amounts of varying size data. Access is restricted to authorised users only, and those users can only run permitted applications within the customer's network.

The workstations 13 require no special configuration.

No special software is required at the workstations 13; access is through a conventional web browser, such as Microsoft Internet Explorer version 4 or above.

Support applications need to be installed only on the terminal servers 16, and not on the workstations 13.

It removes problems associated with NAT (Network Address Translation).

It reduces firewall problems caused by variations in TCP and UDP ports used by different applications. In the system described above, the terminal servers use only TCP port 3389 to communicate between the client session and the server, regardless of the application being run.

It helps to reduce network traffic, since the only network traffic being passed over the link will be screen updates and keyboard/mouse information as opposed to application data.

Possible Modifications

It will be appreciated that many modifications may be made to the system described above without departing from the principle of the present invention.

For example, different server software and different network configurations may be used.

1. A computer system comprising a first network connected to a plurality of further networks,
(a) the first network including a plurality of client computers and a first server computer, having log-on software for allowing a user at any one of the client computers to log on to the first server computer,
(b) the further networks having respective firewalls, the first server computer having permission to access the further networks through their respective firewalls,
(c) each of the further networks including a further server computer having log-on software for allowing a user currently logged on at the first server computer also to log on to the further server computer through the first server computer, and
(d) the further server computer including terminal server software for enabling a remote desktop session to be run on the further server computer from any of the client computers, thereby allowing a user at any of the client computers to remotely run application software in the further server computer.

2. A system according to claim 1 wherein, after the user has logged on to the first server computer, the first server computer presents the user with a list of the further networks that the user is permitted to access, allowing the user to select only from that list.

3. A system according to claim 2 wherein, after the user has logged on to the further server computer, the further server computer presents the user with a list of application programs that the user is permitted to launch, allowing the user to select only from that list.

4. A system according to claim 1 wherein the first network is connected to the further networks by way of the Internet.

5. A system according to claim 1 wherein the first network is an IT support service provider's network, and each of the further networks is a customer's network.

6. A system according to claim 5 wherein the application software in the further server computer comprises support software for remotely diagnosing and repairing faults on a customer's network.

7. A method of operating computer system comprising a first network connected to a plurality of further networks, the first network including a plurality of client computers and a first server computer, and each of the further networks comprising a firewall and a further server computer, the method comprising:
(a) providing the first server computer with permission to access the further networks through their respective firewalls;
(b) logging on a user at any one of the client computers to the first server computer;
(c) after the user is logged on to the first server computer, logging that user on to the further server computer through the first server computer, and
(d) enabling a user at any of the client computers to remotely run application software in the further server computer, by way of a remote desktop session wherein the further server computer receives user input from (and returns display updates to) the client computer via the first server.
